(19) United States
(12) Patent Application Publication
(10) Pub. No.: US 2003/0182153 A1
(43) Pub. Date: Sep. 25, 2003

(54) Commercial method for generating increased purchasing power for consumers while increasing profitability for commercial businesses and intermediary parties

(76) Inventor: Ami Hasson, Rishon LeZion (IL)

Correspondence Address: ROBERT L STONE PC, 13 MEADOWLARK LN, EAST BRUNSWICK, NJ, 08816, US

(21) Appl. No.: 10/386,809

(22) Filed: Mar. 11, 2003

Related U.S. Application Data
(60) Provisional application No. 60/367,608, filed on Mar. 25, 2002.

(51) Int. Cl. G06F 17/00; G06F 17/60

(52) U.S. Cl. 705/1

(57) ABSTRACT

Commercial method for establishment of relationship between the credit card company and/or the intermediate party, and the consumer and the business sector, allowing greater purchase power to be given to the consumer, using the currency units (i.e.—purchase of products/services for the lowest price possible, compared to the other consumer in the same outlet); concurrently this method increases the profits of the business sector accepting the currency units as well as the profits of the credit card company and or the intermediate party that issues them.

This application claims the benefit of U.S. Provisional Application No. 60/357,608, filed Mar. 25, 2002.

### BACKGROUND OF THE INVENTION

In the commercial world, services and products are transferred from one entity to another, in return for some sort of reward.

It is possible to recognize the following three functions that commonly participate in commerce relations: (1) consumers, (2) commercial businesses (e.g. shops, marketing chain, franchises, service providers, etc.) and (3) intermediary parties (e.g. credit card companies, banks, authorized representatives of each etc.). A certain party may play two roles. For instance, a bank usually plays the role of the intermediary, but also can play the role of the commercial business, for example by selling services to its customers (consumers), wherein the means of payment define the relation between the roles.

Several common means of payment exist today which are used to pay for different services and products. For example, cash, bank checks, credit cards and others are all commonly used.

### BRIEF DESCRIPTION OF THE INVENTION

In accordance with certain of its aspects this invention relates to a commercial method for defining a relationship between a consumer, a commercial business and an intermediary party, in which the purchasing power of said consumer is increased while profitability for said commercial business and said intermediary party is also increased, wherein said method comprises:

(i) said intermediary party establishes currency units; and

(ii) an agreement is made between said intermediary party and said commercial business which

(a) defines a limited portion to be paid by said consumer in said currency units for products and services that said consumer purchases from said commercial business,

(a) defines a commission to be paid by said commercial business in local currency that is equivalent to the value of said currency units, in favour of said intermediary party; and

(b) allows said consumer to purchase said currency units with a predetermined discount, which is less than the lowest price available to any other consumer that does not purchase with currency units, thereby enabling said consumer to use said currency units for purchasing said products and services from said commercial business.

### BRIEF DESCRIPTION OF THE DRAWING

The drawing is a flow chart describing procedures according to the invention. It is more particularly described below.

### DETAILED DESCRIPTION OF THE INVENTION

The present invention concerns a new relationship between the above three functions, thus requiring a new means of payment. As before, the three functions still continue to exist and interact. With this new relationship the method of the invention provides advantages to the commercial business and the intermediary party while still increasing the buying power of the consumer over common commercial practice.

According to the invention, a new currency-unit is defined, having an equivalent monetary value for each country in which it is used.

Also according to the invention, the intermediary party, acting on behalf of the business, issues and distributes the service to consumers with a fixed percentage reduction in price, that is a discount. The intermediary party is typically a credit card company, a bank or their authorized representative or the like. The intermediary party is generally the first entity to enter into a commercial relationship with a consumer. Upon the first contact of the consumer with the intermediary party, an account is opened by the intermediary party for the consumer. The consumer may then contact the intermediary party at anytime, asking to reserve in his account a certain amount of currency-units, having a certain monetary value. While reserving these currency-units, the consumer receives the fixed and predetermined percentage reduction in price or discount. For example, a consumer may contact the intermediary party, and ask to reserve in his account currency-units equivalent to $1,000. If the predetermined discount is equal to 15%, the consumer's bank account will be charged for only $850. The predefined discount increases the consumer's buying power. At any time, the consumer may, reserve additional currency-units in his account beyond those originally reserved.

The intermediary party can also set different timetables and programs for charging a consumer for the currency-units he reserves. The program can correspond, for example, to the consumer's financial status, which will be determined, for example by his bank account, securities, credit records and types of credit cards he holds, etc.

The term “currency-units” used herein, signifies a monetary value in “currency units” separate from the local currency for accounts of each of the consumer and the commercial business. The accounts are held by the intermediary party. Other equivalent terms for the currency units may be used for the premium, such as “buying power”, “money+” etc.

The consumer's increased buying power is translated into increased commercial activity, such as an increased number of potential clients in the shops. For every business, an increase in the number of clients gives rise to an increase of the return and profitability of the business. For this reason, the invention provides profit for the businesses. According to the invention, to take the commercial business' role, the business signs a contract with the intermediary party, according to which a currency-unit account is opened for the business, and a limited portion is allocated, for the business' clients (consumers) to use their reserved currency-units. For example: if the limited portion is 20% and a client purchases an item (product) having a value of $100, then the client is allowed to pay from his reserve account $20 (20%×$100) in currency-units, and the remainder, i.e. $80, must be paid by using the regular local currency.

The limited portion is set by the intermediary party according to the contract signed with the commercial business. According to the invention, the intermediary party can set different limited portion values according to the different commercial businesses' products. For example: Food branches will typically enjoy a smaller limited portion (for example: 20%) compared to, say, ajewelry business (which typically can enjoy a limited portion of, say, 50%). Indeed it is an aspect of this invention that, particularly when the business is a marketing chain business in a retail product sector, the limited portion available for use by clients in currency units can be 100% on all items sold by the marketing chain or on predetermined lines of its products.

It is also desirable that the commercial business and/or the intermediary party prominently publicize the availability of currency units in accordance with the commercial method of this invention including the limited portion of purchase prices available to consumers for purchase of some or all of its products or services or particular commercial businesses.

Note that the consumer enjoys the fixed discount only on the limited portion paid by him from his currency-units. For example: A client buys food for $100. If the limited portion is 20%, he has to pay $80 in the local currency, and the remainder, $20, can be paid in currency units. As every consumer enjoys a 15% fixed reduction (by this non-limiting example), the client enjoys a $3 discount (15%×$20=$3). Another example: A client purchases goods in a jewelry shop for $100. If the limited portion is 50%, than $50 will be paid in the local currency, and the equivalent of $50 will be paid by currency-units. With a fixed reduction of 15%, 15%×$50−$7.50, the client automatically enjoys a $7.50 discount.

The use of currency-units should not prevent the client from enjoying any general sale, preferred customer sale or reduction a particular business advertises to the public. If the jewelry shop (that enjoys the 50% limited portion, as mentioned in the last example) declares a 50% sale, and the client buys for $200, he would pay a total of $100, $50 out of which will be in local currency, and the balance (remainder), i.e., $50, in currency-units. As computed before, the client will enjoy in this case a $7.50 discount, which together with the $100 reduction (according to the sale), reaches a total of $107.50. Thus, customers participating in currency units will have greater purchasing power than all other customers, including preferred customers.

While signing the contract between the intermediary party and the commercial business, a commission is set from the business' currency unit account on behalf of the intermediary party. For example, the intermediary party may charge an 18% commission. Therefore, in the jewelry shop's transaction discussed above, the account of the jewelry shop is credited with currency-units equivalent to $41 (82%×$50) instead of $50.

The commission, according to the invention, must be higher than the fixed discount granted the consumer and is the intermediary party's profit of $9, (that is $50−$41) in the example immediately above. Also, joining a group of commercial businesses is profitable to a business, as long as the commission is lower than the increase in return brought about by joining the group.

According to the consumers' membership terms, unused currency-units would be reimbursed after a certain pre-determined time period (e.g., 6 months, 1 year, etc.) The reimbursement period assures the intermediary party's profit also in extreme cases in which no purchases are made through the currency-units reserved by the consumer, since the money would have been in the intermediary party's possession for that period and could, for instance, accumulate interest for the intermediary party.

The following illustrates a manner in which the customer, the intermediary party and the business operate with a currency units account:

A. The customer dials a telephone number provided by the intermediary party for its currency units customers;

B. The customer then keys in the number of the credit card or bank account he is using as well as his Personal Identification Number;

C. The customer then keys in the amount of currency units he is purchasing;

D. Within the time required for the intermediary to confirm the ability of the customer to purchase the number of currency ordered in C, above (generally from a few seconds to one or two business days), confirmation of the purchase is given to the customer, typically by telephone, facsimile and/or e-mail;

E. Concurrent with the confirmation in D, above, the intermediary party charges the customers credit card a account or debits his bank account for the amount of currency units purchased;

F. When the customer makes a purchase with currency units from a participating business the business determines the number of currency units the customer has available (typically by “swiping” his credit or debit card and the number of currency units appropriate for the purchase is deducted from the currency units available (by way of example, if a customer orders $1,000 in currency units on Mar. 3, 2003, has them confirmed to his account and has them available for a purchase made on Apr. 1, 2003, for which the limited portion is 15%, $850 worth of currency units are deducted from his account, leaving $150).

It is noteworthy that provision may be made to pay for the currency units purchase at once or in installments. Further, if when making a purchase a customer exhausts his currency units and a balance remains he may pay the balance by credit, debit cards or cash or purchase new currency units for at least the balance.

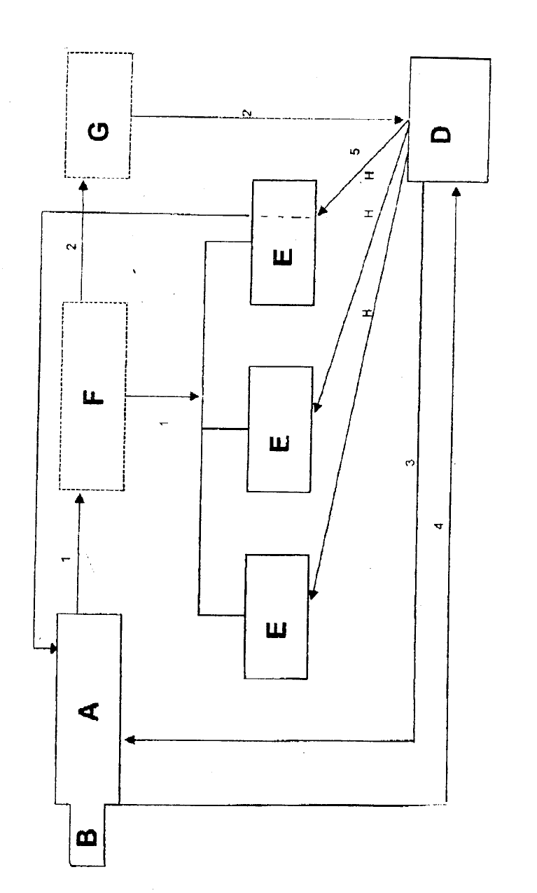

The main steps in the method of the invention are illustrated in the flow chart of FIG. 1 in a self-explanatory manner. In the FIGURE::

1. Signing the agreements, F, (step 1) between credit card company and/or bank, A, on their behalf with the marketing chains, stores, etc., E, pertaining to and defining currency units, B;

2. Advertising with customer oriented advertisements, G, for potential customers, D (steps 2);

3. The customers, D, approach the credit card company or bank, A, and/or marketing chains, stores, etc., E, and requests a certain amount of currency units, B (step 3);

4. The customer, D, receives an approval for the currency units (step 4) and concurrently computers are fed to all parties;

5. Purchase, H, is carried out by the customer, D (step 5) and his balance is modified accordingly.

Steps 3-5 are repeated for additional currency units and purchases with them.

The invention is not bound by the specific examples and flow of the drawing as described above.

It should be understood that the relation between the intermediary party (e.g., a credit card company or bank) and the commercial business (e.g., shop), as well as the management of the customer's relationship with the intermediary party, can be controlled under a suitable computer system or other electronic means. The latter is preprogrammed to record the agreement conditions and manage the selling/purchasing operations. Payments using currency units may be made with a special currency units credit or debit card separate from an ordinary credit or debit card or with a card programmed to include both currency units and non-currency units purchases. Desirably the customer receives a voucher for currency units purchases, which may be encoded, for instance with a bar code.

1. A commercial method for defining a relationship between a consumer, a commercial business and an intermediary wherein said method comprises:
(i) said intermediary party establishes currency units; and
(ii) an agreement is made between said intermediary party and said commercial business which:
(a) defines a limited portion to be paid by said consumer in said currency units for products and services that said consumer purchases from said commercial business,
(b) defines a commission to be paid by said commercial business in local currency that is equivalent to the value of said currency units, in favour of said intermediary party; and
(c) allows said consumer to purchase said currency units with a predetermined discount, which is less than the lowest price available to any other customer that does not purchase with currency units, thereby enabling said consumer to use said currency units for purchasing said products and services from said commercial business.

2. The method according to claim 1, wherein the commercial business is at least one of the following: shop, franchise, and service provider.

3. The method according to claim 1, wherein the intermediary party is at least one of the following: a credit card company and a bank.

4. The method according to claim 1, wherein said commercial business comprises a group of commercial businesses.
